(19) United States
(12) Patent Application Publication
(10) Pub. No.: US 2026/0017698 A1
(43) Pub. Date: Jan. 15, 2026

(54) POINT OF SALE DATA FILTERING SYSTEM

(71) Applicant: TOSHIBA GLOBAL COMMERCE SOLUTIONS, INC., Durham, NC (US)

(72) Inventors: Susan W. BROSNAN, Durham, NC (US); Jessica SNEAD, Durham, NC (US); Patricia HOGAN, Durham, NC (US); Daniel R. GOINS, Durham, NC (US)

(73) Assignee: TOSHIBA GLOBAL COMMERCE SOLUTIONS, INC., Durham, NC (US)

(21) Appl. No.: 18/767,501

(22) Filed: Jul. 9, 2024

(51) Int. Cl. G06Q 30/0601

(52) U.S. Cl. CPC G06Q 30/0607

(57) ABSTRACT

Methods and systems of providing need-to-know information to a user are disclosed. In some aspects, when a user, via the user device (e.g., a mobile phone), has entered a predetermined geographic zone associated with a predefined location (e.g., a grocery store, concert/sporting venue, festival, etc.) (or when the user has entered the location to travel to into the user device), data is retrieved, from a database over the network, that relates to policies and information associated with the location being traveled to. The policies and information associated with that location are then sent to the user so that the user will have need-to-know information with the location he/she is traveling to.

### BACKGROUND

Different stores, venues, etc. have different shopping rules, practices, regulations, etc. especially when it comes to different cities, countries, etc. People do a lot of activities where knowledge of such rules, practices, regulations may be helpful. For example, when traveling to an arena for a concert, it may be useful to know the rules and policies (e.g., what items you can bring and what the bag policies are). Moreover, different counties, cities, states, countries have different shopping rules, practices, regulations, etc. When shopping somewhere a user does not normally shop it would be good if he knew certain information, such as where you have to bring a Euro coin to unlock a shopping cart, what stores you have to bring your own bags, that in New Jersey you cannot pump your own gas, that certain airports and venues do not accept cash, or that the restaurant you are going to does not take your favorite credit card. It would also be useful to know when you go to events at various locations what the parking, park and ride, no-bag, clear-bag, bag size, etc. policies are.

### BRIEF DESCRIPTION OF THE DRAWINGS

The objects and features of the present disclosure can be better understood with reference to the drawings described below, and the claims. The drawings are not necessarily to scale, emphasis instead generally being placed upon illustrating the principles of embodiments of the present disclosure. In the drawings, like numerals are used to indicate like parts throughout the various views.

FIG. 1 illustrates a system of providing need-to-know information in accordance with one embodiment.

FIG. 2 illustrates an example of providing need-to-know information in accordance with one embodiment.

FIG. 3 illustrates another example of providing need-to-know information in accordance with another embodiment.

FIG. 4 illustrates yet another example of providing need-to-know information in accordance with yet another embodiment.

FIG. 5 illustrates still yet another example of providing need-to-know information in accordance with another embodiment.

FIG. 6 illustrates a method of providing need-to-know information in accordance with one embodiment.

FIG. 7 illustrates a method of providing need-to-know information in accordance with another embodiment.

### DETAILED DESCRIPTION OF THE EMBODIMENTS

The present application has developed systems and methods for providing certain helpful information to users which would make a better experience for the user. For example, in some aspects, when a user, via the user device (e.g., a mobile phone), has entered a predetermined geographic zone associated with a predefined location (e.g., a grocery store, concert/sporting venue, festival, etc.) (or when the user has entered the location to travel to into the user device), data is retrieved, from a database over the network, that relates to policies and information associated with the location being traveled to. The policies and information associated with that location are then sent to the user so that the user will have need-to-know information for the location he/she is traveling to.

Generally, embodiments of the present disclosure are described below. In at least one example, the present disclosure describes a service that uses publicly available information to build a list of information to warn a user about what he needs to know before going into the store or event location, for example. The service could gather information from searching store-posted information, customer reviews and other internet information about the location. There could be warnings or comments about parking limitations or need to pay for parking, or the best place to park for the location or public transport to location or preferred parking for people with disabilities and services to shuttle them to the event or pickup an electronic shopping cart. It could also warn about needing to bring your own bags, acceptable tender types, tipping policy, self-pumping gas or attendant-pumping gas, self-checkout only or packing your own groceries, bag size limit, clear bag policy, etc.

In one embodiment, a method includes: receiving, at a server from a user's device comprising a processor over a network, travel data comprising a location being traveled to by a user; retrieving, from a database over the network, data comprising policies and information associated with the received location; selecting, by the server, which policies and information associated with the received location should be sent to the user's device; and sending, from the server to the user's device over the network, the selected policies and information associated with the received location.

In another embodiment, a server comprising a processor configured for: receiving, at a server from a user's device comprising a processor over a network, travel data comprising a location being traveled to by a user; retrieving, from a database over the network, data comprising policies and information associated with the received location; selecting, by the server, which policies and information associated with the received location should be sent to the user's device; and sending, from the server to the user's device over the network, the selected policies and information associated with the received location.

Various examples of the present disclosure will now be described. The following description provides specific details for a thorough understanding and enabling description of these examples. One skilled in the art will understand, however, that the present disclosure may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the present disclosure. Certain terms may even be emphasized below; however, any terminology intended to be interpreted in any restricted manner will be overtly and specifically defined as such in this Detailed Description section.

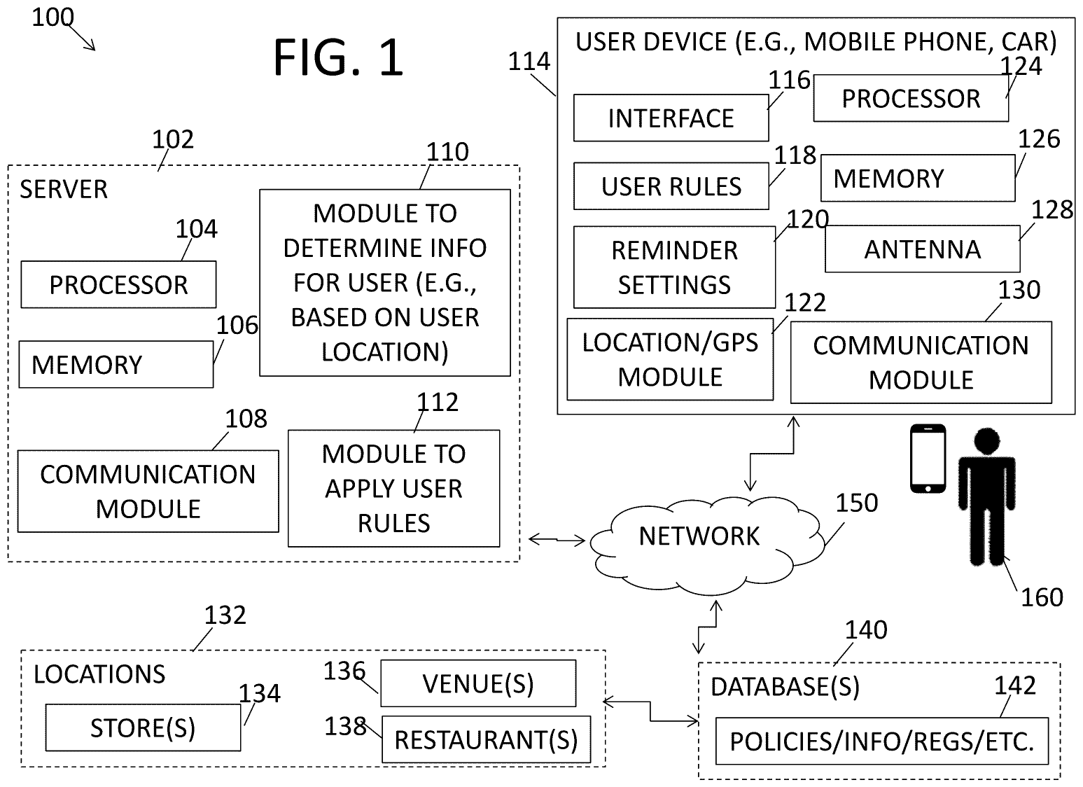

Details of various embodiments are described in more detail below with reference to FIGS. 1-7, which are provided as exemplary embodiments, and the present present disclosure should not be limited to such embodiments.

FIG. 1 illustrates a system of providing need-to-know information in accordance with one embodiment. The system includes a server 102, a user device 114, a network 150, and/or one or more databases 140 which work in combination with a user 160 traveling to various locations 132 (e.g., stores 134, venues 136, restaurants 138, etc.). Each of these are discussed below.

First, the user device 114 may be any electronic device associated with the user, such as a mobile cellular phone, computer, a tablet, a watch, the user's car/vehicle, or any other device associated with the user which can connect to the network 150. FIG. 1 illustrates that the user device 114 is a cellular phone.

The user device 114 may include an interface 116, user rules 118, reminder settings 120, location/GPS module 122, a processor 124, memory 126, an antenna 128, a communication module 130 or any combination thereof.

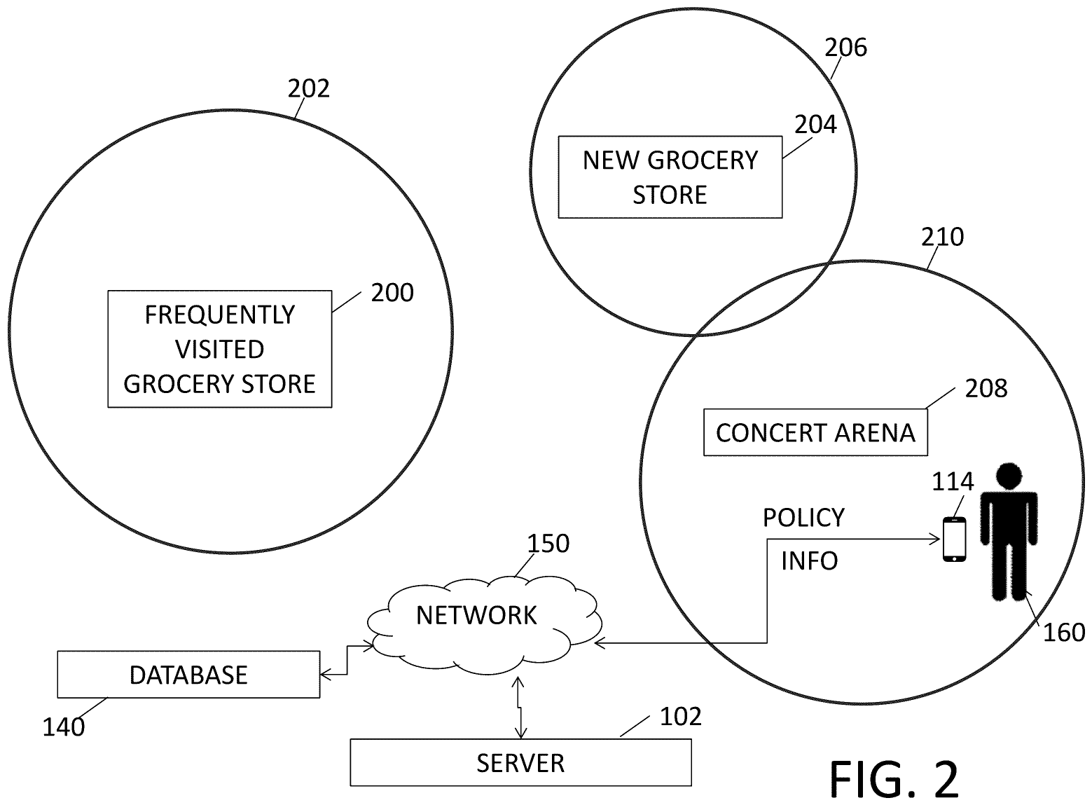

The interface 116 may include a network interface and a user interface. The network interface 116 can be used to interface with the server 102. A computer program operates or runs on the processor 124 via the memory 126 using the network interface. The programs include computer-executable instructions that accesses data and modules, such the user rules 118, reminder settings 120, the location/GPS module 122 and communication module 130 to allow the system 100 to provide need-to-know information to the user, as described more in depth later with regard to FIGS. 2-7. These computer-executable instructions, data and modules may be embodied in transitory or non-transitory computer-readable mediums, as is discussed in more detail later.

The user interface is used for interacting with the user and displaying the need-to-know information for the user 160. The user interface is configured so that the user can input data into the user device 114.

The system 100, the user device 114, or a combination thereof can determine the information to communicate with the user 160. As such, any of the modules/data on the server 102 may be included on the user device 114 and vice versa. Accordingly, the present application could be wholly embodied in the user's device 114 or via the server 102.

As mentioned above, the system 100 includes at least one processor 124 and memory 126. The processor 124 can be provided by a general-purpose microprocessor or by a specialized microprocessor (e.g., an ASIC). In one embodiment, the system 100 can comprise a single processor which can be referred to as a central processing unit (CPU). In another embodiment, system 100 can comprise two or more processors, for example, a CPU providing some or most of the system functionality and a specialized microprocessor performing some specific functionality. A skilled artisan would appreciate the fact that other schemes of processing tasks distribution among two or more processors are within the scope of this disclosure.

The memory 126 can include RAM, memory storage, and any of a variety of other types of memory components, in various embodiments. The memory storage may illustratively be or include a flash memory, a hard disc drive, any type of ROM, EPROM, EEPROM, or any other type of volatile/non-volatile or removable/non-removable memory or data storage components, in various embodiments. The processor 124 can be configured to read executable instructions from the memory 126, including RAM.

The user device 114 also includes an antenna 128. The antenna 128 may be used to connect the user device 114 with the network 150, and thus, with the server 102, database, etc. The antenna 128 is configured to support, for example, but not limited to, the following protocols: at least one protocol of the IEEE 802.11/802.15/802.16 protocol family, at least one protocol of the HSPA/GSM/GPRS/EDGE protocol family, TDMA protocol, UMTS protocol, LTE protocol, 5G/6G protocol and/or at least one protocol of the CDMA/1×EV-DO protocol family.

The user rules 118 are rules that the user establishes for providing information to the user. For example, the user may establish rules that certain locations do not provide information to the user. For example, certain locations that are well known to the user may not need information provided to the user. However, the user rules 118 may allow the user to allow for only policies, rules, regulations, etc. which may have changed recently or since the last time the user visited such location. The user may establish any user rules 118 which establishes when and how the information is provided to the user as well as what type of information is to be provided to the user.

The reminder settings 120 are settings on when reminders are to be provided to the user. This includes reminders that are provided to the user even though the user may or may not know the policies, rules, regulations, etc. In some embodiments, the user can set that there will be no reminders, some reminders for certain situations (e.g., always remind to bring bags when going to any grocery store, never provide reminders of policies of favorite restaurants, provide reminders for a month after new policies are implemented, etc.), reminders for common tasks (e.g., traveling to/from home/work/school/church/etc.).

There could be reminder settings so that the user could specify what kind of alerts a user is interested in receiving. For instance, if the user does not need alerts about anything when the user goes to his favorite local grocery store, a reminder is needed if he goes to a different grocery store. Similarly, the user does not need a reminder if he is a season ticket member for hockey games and already knows what he can bring into the arena. However, this is not true for every arena, because the user needs alerts if he goes to a different event arena even for his local team.

The user might specify that he never wants to receive warnings about plastic bags, if he already brings his own shopping bags everywhere and does not want to be barraged by those warnings. The warnings could also be remembered by the device that is doing the warning. For instance, if the warning came from the user's device (e.g., a mobile phone), it can remember when the last time it displayed a warning or the last time the user was in this location (i.e., parking lot or state). If the warning was from a website on a browser on the user's device, it can remember the last time the user visited this website and know that the user already saw the warning about the changes. If this is something that is deemed to be a recurring warning or the time limit has passed, it might warn the user again anyway.

The location/GPS module 122 is configured to provide the user's current location or a future destination of the user to the server 102. The location/GPS module 122 accesses the antenna 128 to be able to transmit the user's current location to the server 102 so that the system 100 knows when the user has arrived at a location 132, in some embodiments.

In other embodiments, the location/GPS module 122 is configured to determine where the user is traveling to. For example, the location/GPS module 122 may access the user's calendar, a GPS-entered address, or any other method to determine or predict the user's end destination. In this regard, if the user enters an address of a location 132 into his vehicle's GPS, the location/GPS module 122 records that address and then communicates it to the server 102 for processing to determine the need-to-know information.

The communication module 130 is configured to provide communications to/from the server 102 via the network 150 using the protocols discussed above. The communication module 130 is configured to access the other modules of the user device 114 in order to transmit information to/from the user device 114. For example, the communication module 130 accesses the location/GPS module to transmit the user's location (or future destination) to send to the server 102, which then will provide back to the user's device 114 the need-to-know information to the user.

The server 102 includes a processor 104, memory 106, a communication module 108, a module to apply user rules 112, and a module to determine information for the user 110.

The processor 104, memory 106, and the communication module 108 of the server 102 are similar to the processor 124, memory 126 and the communication module 130, respectively, of the user device 114.

The module to determine info for the user (the info determination module) 110 is configured to determine the need-to-know information for the user using the current location or future destination via the location/GPS module 122 which is transmitted from the user device 114 to the server 102 over network 150. The user rules 118 and reminder settings 120 may also be transmitted to the server 102 from the user device 114.

The information that can be determined can be any information that may be helpful to the user in shopping, attending events (e.g., concerts, sporting events, festivals, etc.), going to restaurants, going to locations with others (e.g., kids, families, those with disabilities, etc.), traveling nationally/internationally, etc. For example, when going to a grocery store, the information could be that the store no longer provides bags so the user needs to know to bring their own bag.

The info determination module 110 is configured to warn/alert the user about what he needs to know for various situations, such as (1) when the user searches for directions to the location type the address into his GPS system, (2) when the user is doing his shopping list, (3) looking at his e Wallet application to check his electronic tickets or clipped eCoupons (4) when he enters the geofenced area beside the location.

Depending on the location, the info determination module 110 may choose the reminders. If the user is at the location, the info determination module 110 may remind the user to leave his weapons (e.g., guns, knifes, etc.) in the car, get the user's clear re-usable bags out of the trunk, etc. If the user is making a shopping list, the info determination module 110 might alert the user to bring change for the shopping cart and a credit card to pay.

The module to apply user rules 112 is configured to receive the user rules 118 on the user device 114 and then use those rules for the info determine module 110.

FIG. 2 illustrates an example of providing need-to-know information in accordance with one embodiment. As shown, there are three locations: a grocery store 200 that is frequently visited by the user 160, a grocery store 204 that is new to the user 160, and a concert arena 208. Each of these locations have geographic boundaries 202, 206, and 210, respectively, in which when the user 160 enters these boundaries, the system 100 determines that the user is at the location. For example, FIG. 2 illustrates that the user 160 and the user's device 114 is within the boundary 210 associated with the concert arena 208. As such, in response to the user's device 114 sending the user's current location and such location being within the arena's boundary 210, the server 102 determines that the policy information about the arena 208 (via database 140) should be sent to the user 160 via the user's device 114. It should be understood that other information could also be sent to the user, including the arena rules (e.g., what the user is allowed to bring to the arena, parking information, etc.), what the user should bring to the arena, if there will be food/beverages sold, event information, and the like.

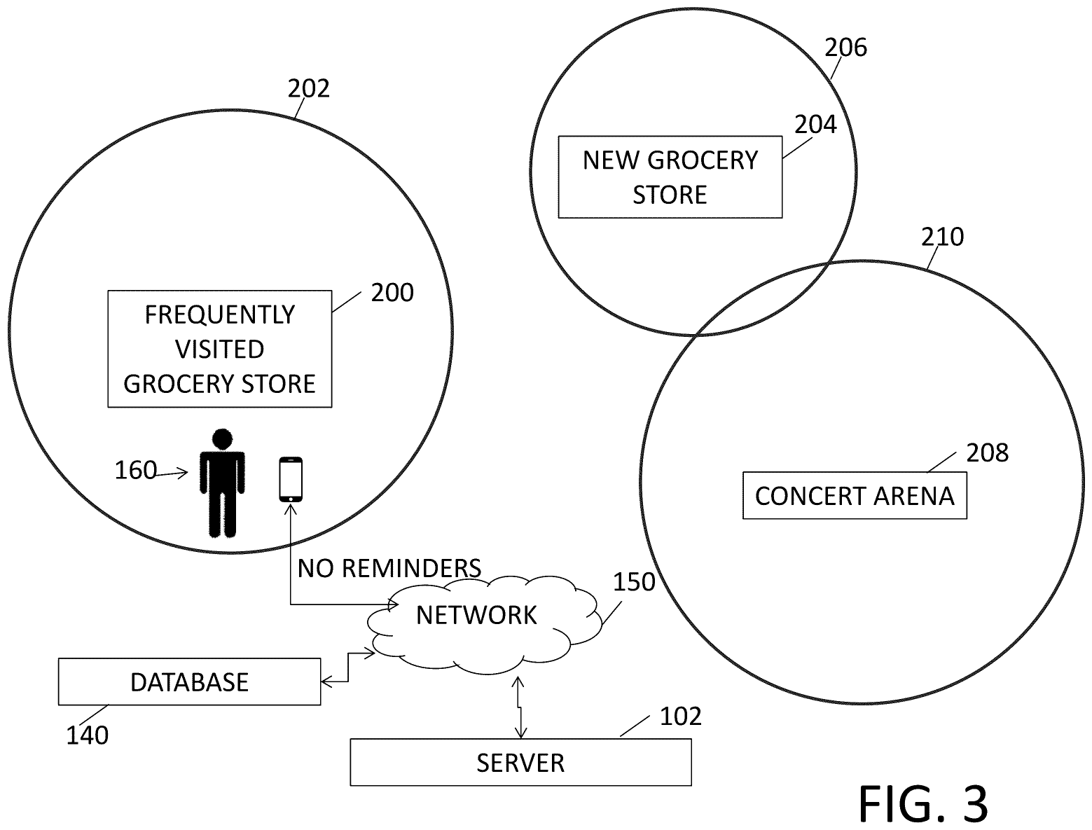

FIG. 3 illustrates another example of providing need-to-know information in accordance with another embodiment. In this embodiment, the user 160 is visiting the frequently-visited grocery store 200. As such, the user device 114 sends to the server 102 via network 150 that the current location of the user 160 is within the boundary 202 of the store 200. The server 102 will then access the user's rules and reminders on the user's device 114 and determine that the user has said that there should be no reminders for frequently-visited locations. Thus, as shown in FIG. 3, no reminders will be sent to the user. However, in some embodiments, if the policies/regulations/rules/information/etc. about the grocery store 200 have changed (by checking database 140 for example) within a predetermined time frame, the server 102 may send reminders or information to the user since the user may not be aware of or remember such change.

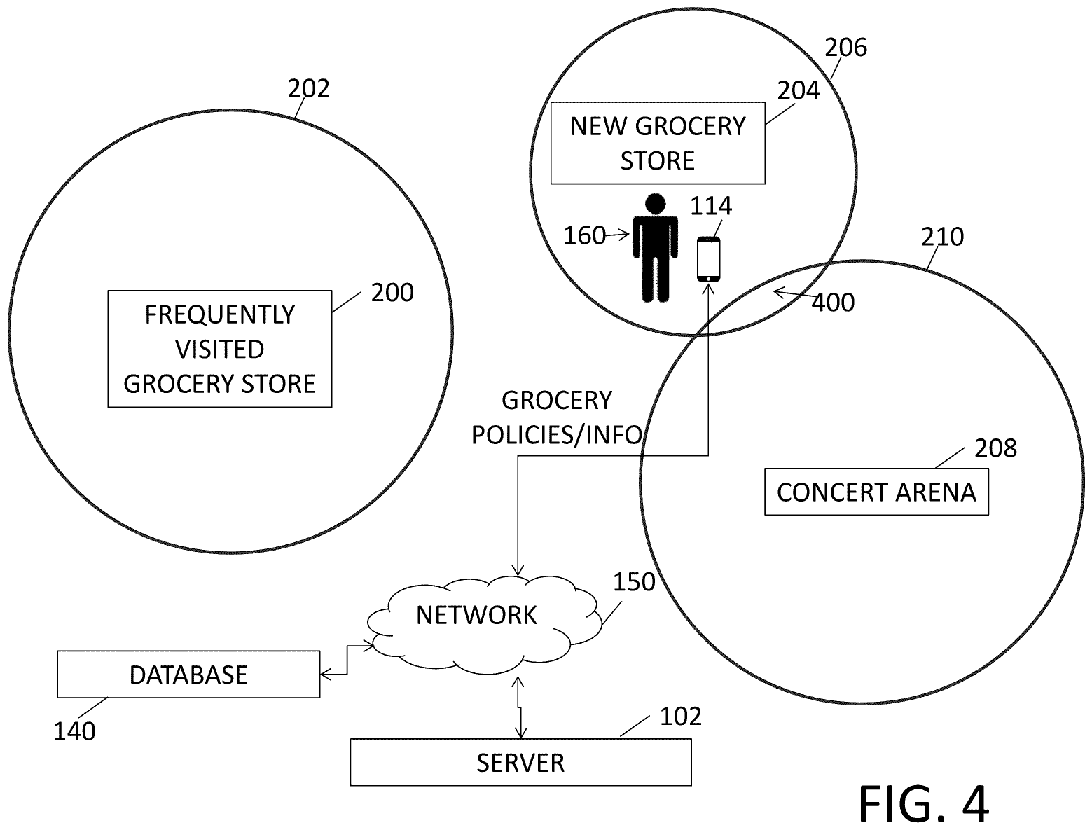

FIG. 4 illustrates yet another example of providing need-to-know information in accordance with yet another embodiment. As shown, the user 160 is within the boundary 206 of a grocery store 204 that is new to the user 160. Thus, the user's device 114 sends a message to the server 102 and in response, the server 102 accesses the grocery store's policies/info/rules/etc. via the database 140 and sends such information to the user via network 150.

It should be noted that if the user's device 114 is within an area 400 common to both boundaries 210 and 206 of the arena 208 and grocery store 204, respectively. As such, the system 100 could send policies/info for both locations or determine which location is the location the user is actually heading to and then send information for that intended location.

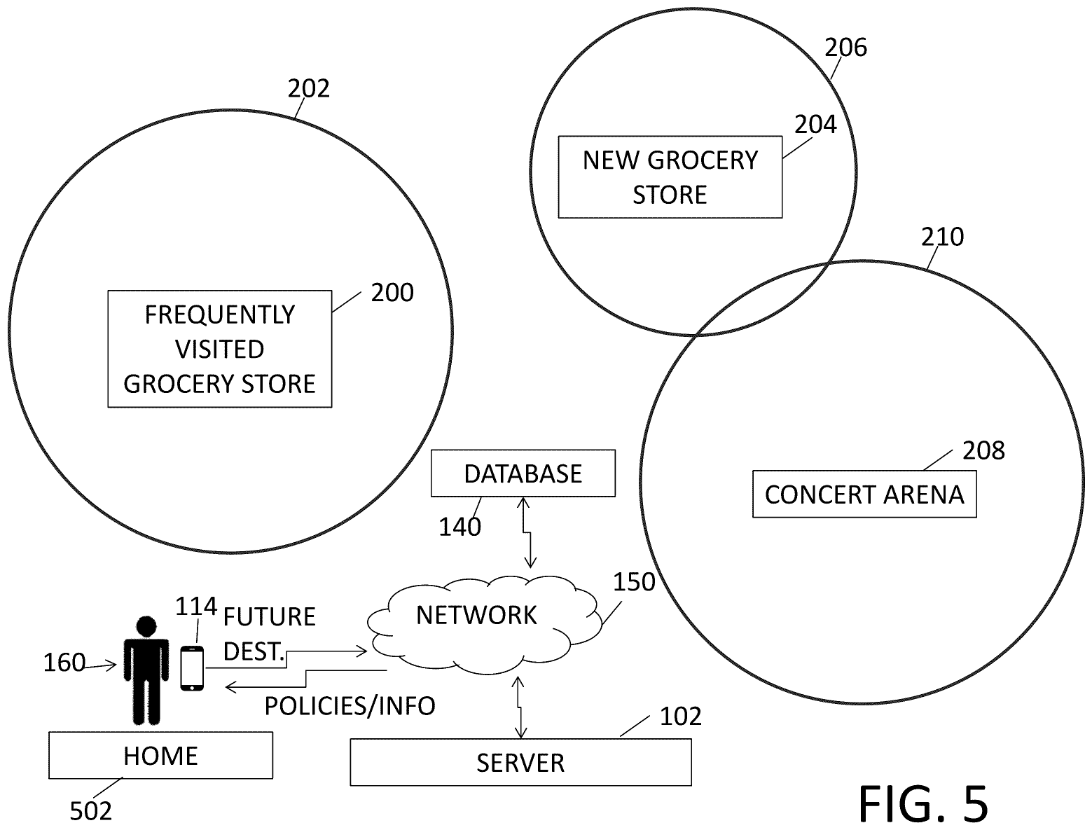

FIG. 5 illustrates still yet another example of providing need-to-know information in accordance with another embodiment. In this example, the user has not arrived at the destination and instead the user enters an address of a location 132 into his vehicle's GPS as to where the user is traveling to. Then, the location/GPS module 122 records that address and then communicates it to the server 102. The server 102 then determines the need-to-know information associated with the destination address and transmits it to the user's device 114.

It should be noted that that instead of the user entering the destination address, the system 100 could instead perform predictive techniques to determine where the user is likely headed to and provide need-to-information for this predicted address.

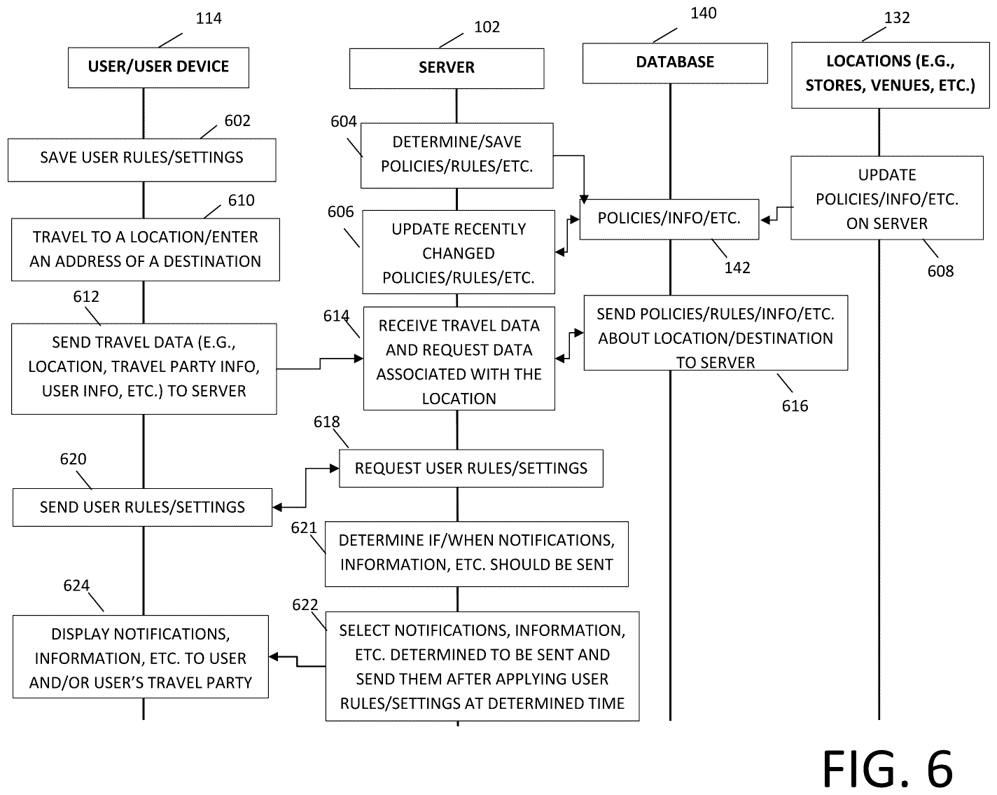

FIG. 6 illustrates a method of providing need-to-know information in accordance with one embodiment. As shown in block 602, the user saved the user's rules and settings. These rules or settings are discussed above and could be saved on the user's device 114 and/or on the server 102.

In block 604, the server 102 may determine the policies, rules, regulations, information, etc. 142 about various locations 132. This may be accomplished, for example, by using a web crawler program to browse the internet to access publicly-available data.

Once the server 102 determines the policies, rules, regulations, information, etc. 142, the server 102 may update, save, and/or create the policies, rules, regulations, information, etc. 142 in the database 140 for the respective locations 132, are shown in block 606.

In another embodiment as shown in block 608, the locations 132 may create or update their own policies, rules, regulations, information, etc. 142 in the database 140. In other words, when a location 132 that has policies, rules, regulations, information, etc. 142 on the database 140, the location 132 can provide updates and save such updates on the database 140 so that the database 140 has the latest policies, rules, regulations, information, etc. 142 for that location.

The below description with regard to blocks 610-622 of FIG. 6 illustrates the server 102 providing the need-to-know information to the user via the user's device 114. In block 610, the user and the user's device 114 travel to a location or the user enters an address/destination that the user will be traveling to.

In block 612, the travel data including location is then transmitted to the server 102 over the network 150. The travel data may include not only the location of where the user is going but also other information about the user's travels, such as who all are joining the user at the location (i.e., the travel party), information about the user (and/or anyone in the user's party) (such as age, height, weight, sex, disabilities, food allergies, special needs, etc., mode of transportation by the user (e.g., car, bicycle, scooter, walking, etc.), whether the user has ever been to the location or if this is location is frequently visited by the user, etc.

The travel data may be sent from the user's device 114, a computing device of another user in the user's party, etc. Part of the travel data may be accessed from a location remote from the user, such as on the server 102 or in a database. For example, the travel data may also include when the last time the user has been to the received location/destination and while such data may be sent from the user's device, it may also be accessed from in a database or from the server 102 if such data has been stored at these devices.

In block 614, the server 102 receives the location from the user's device 114 (or other locations, such as the server 102, database, etc.). In response to receiving the location, the server 102 requests the policies, rules, regulations, information, etc. 142 associated with the received location. This may be achieved by the server 102 querying the database 140 with the received location and then the database 140 will return all data that matches such received location, as shown in block 616.

Also, when the user visits the location, the server 102 will save the date of such visit either in database 140, another database, on the server 102, or on another device (such as the user's device 114) for future use.

In block 618, the server 102 requests the user rules 118 and reminder settings 120 from the user's device 114 and/or from a database 140 or from the server 102 (based on where such user rules 118 and reminder settings 120 are stored). The user rules 118 and reminder settings 120 are then transmitted to the server 102 (such as from the user's device 114 to the server 102, as shown in block 620).

It should be understood that the user rules 118 and reminder settings 120 can be stored in either the user's device 114, the server 102 or a database, such as database 140 or a database separate from database 140. Also, one or more of the operations that occur on the server 102 may occur on the user's device 114 and one or more of the operations that occur on the user's device 114 may occur on the server 102. In this regard the exemplary embodiments described herein should not limit the present disclosure.

Referring back to FIG. 6, in block 621, the server 102 determines which notifications, information, rules, regulation, etc. 142 that should be sent to the user's device 114. This may include analyzing the user's data including who the user is traveling with, the location the user is going, how familiar the user is with the location, needs of the user, needs of the user's party traveling to the location, information that may not be obvious (e.g., weather conditions based on querying a weather database), how recent the policy has changed, whether the user has been to the location since policy changes, if the information has already been sent to the user within a predetermined amount of time, etc. When analyzing this data, the system will determine what information, rules, regulations, etc. 142 are relevant for the user and/or would be useful for the user. For example, if the user is traveling to a grocery store that just changed their policy about not providing bags to carry out groceries, the server 102 may determine that the user is traveling to a location where the user is likely unaware of such changes (particularly if the server 102 recognizes that the user has not been to the store since the policy change). This is based on the server 102 knowing when the policy change occurred (based on publicly available information that the server 102 found on the internet or based on the stored updating database 140 with such information) as well as pulling data from a database (either database 140 or another database) indicating the last time the user has visited the grocery store.

The server 102 may also determine the correct timing to send the notifications and information. For example, the server 102 should warn the user about what he needs to know for various situations at particular times/events/triggers occurring, such as when the user: (1) searches for directions to the location type the address into his GPS system, (2) is doing his shopping list, (3) is looking at his e Wallet application to check his electronic tickets or clipped eCoupons (4) enters the geofenced area (similar to areas 202, 206, and 210 of FIGS. 2-5) beside the location, (5) while the user is still in his vehicle, and the like. The notifications could be sent immediately when these items occur and are sent in accordance with the user's rules 118 and reminder settings 120.

In block 622, the server 102 will send alerts, notifications, etc. of the information, policies, rules, regulations, etc. 142 associated with the location that was received. In some embodiments, the information, policies, rules, regulations, etc. are only sent in accordance with the user's rules 118 and reminder settings 120 set up by the user. In this regard, the server 102 will determine whether or not to send the information, policies, rules, regulations, etc. based on the user's prestored settings.

In some embodiments, the server 102 will send such information, policies, rules, regulations, etc. 142 when the user arrives at the location 132 or can provide an immediate alert in response to receiving the address of the received location 132 (after retrieving the information, policies, rules, regulations, etc. 142 of that location).

In block 624, the user's device is able to output (e.g., display) the information 142 to the user. The output may be visual via a display on the user's device 114 or a display on a device associated with the user's device. In another embodiment, the output maybe an audio on the user's device 114.

Once the user receives the information, policies, rules, regulations, etc. of the location, the user will be able to act accordingly. For example, once a notification is provided to the user that the grocery store does not have bags and the user receives this notification when exiting his car, the user then will grab a reusable bag from his car.

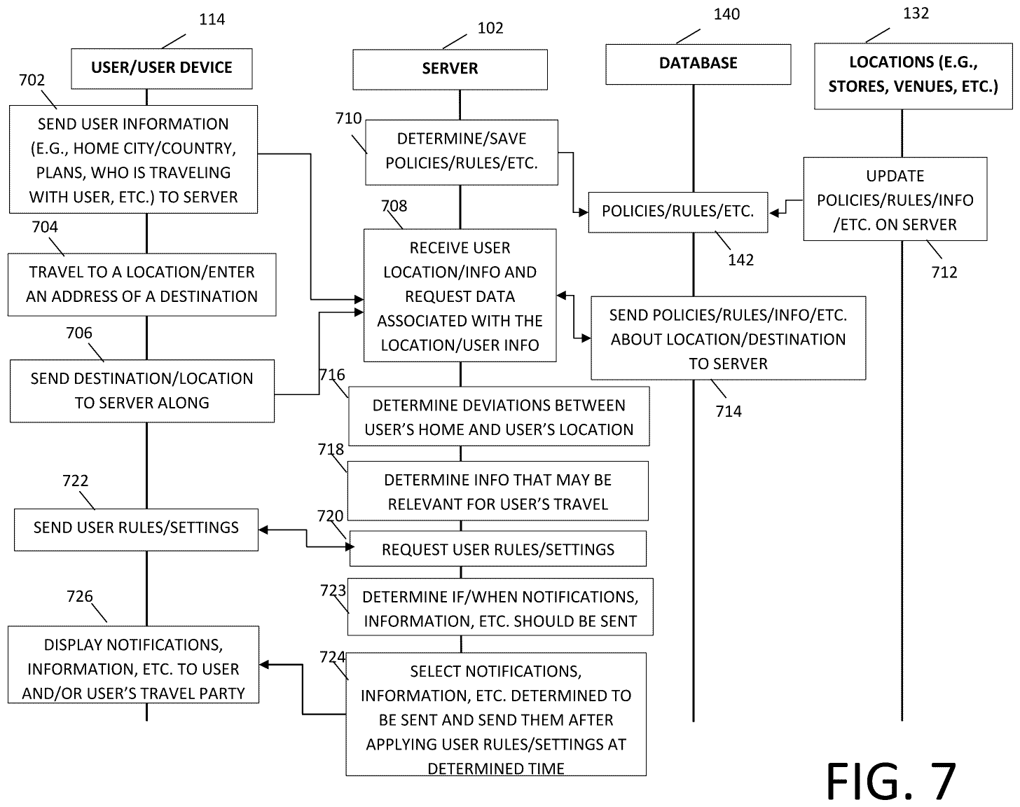

FIG. 7 illustrates another method of providing need-to-know information in accordance with another embodiment. FIG. 7 is similar to FIG. 6 but includes examples of determining deviations of the user's destination with previous destinations or the user's home country/state/city.

In block 702, the user's information is sent to the server 102. This information can be the user's age, user's health, user's home area (home country, city, state), locations that the user is familiar with (i.e., has traveled to a predetermined amount of times), the mode of transportation the user is traveling in, the user's special needs, etc. This information is important for the server to make determinations as to whether or not to provide certain information to the user.

The user's information may include various other information and the present disclosure should not be limited. For example, as mentioned above with regard to FIG. 6, the user's information may also include the following: who the user is traveling with, the location the user is going to, needs of the user's party traveling to the location, whether the user has been to the location since policy changes, what information has already been sent to the user within a predetermined amount of time, etc.

The user's information (i.e., user's travel data) may be sent to the server 102 from the user's device 114, a computing device of another user in the user's party, etc. Part of the user's information may be accessed from a location remote from the user, such as on the server 102 or in a database. For example, the user's information may also include when the last time the user has been to the received location/destination and while such data may be sent from the user's device, it may also be accessed from in a database or from the server 102 if such data has been stored at these devices.

In block 704, the user and the user's device 114 travels to a location or the user enters an address/destination that the user will be traveling to.

In block 706, the location is then transmitted to the server 102 over the network 150. Additional information may be included with such location being sent, including whether the user has ever been to the location or how many times, the frequency of the user visiting this location, the last time the user has been to the received location/destination, and the like. Moreover, if the user is not at the location, the current location of the user may also be sent to the server 102 in addition to the eventual address of where the user is traveling to.

In block 708, the user information and location/destination information is received by the server 102. The server 102, upon receiving such information, will then send a request to the database 140 (or other databases, server 102, user device 114, etc.) for data associated with the received location.

In block 710, the server 102 may determine the policies, rules, regulations, information, etc. 142 about various locations 132. This may be accomplished, for example, by using a web crawler program to browse the internet to access publicly available data about the location. For example, if a concert venue posts it's policies on its website, the server 102 can add such policies 142 to the database 140.

Once the server 102 determines the policies, rules, regulations, information, etc. 142, the server 102 may update, save, and/or create the policies, rules, regulations, information, etc. 142 in the database 140 for the respective locations 132, a shown in block 606.

In another embodiment as shown in block 712, the locations 132 may create, store, and/or update their own policies, rules, regulations, information, etc. 142 in the database 140. In other words, when a location 132 that has policies, rules, regulations, information, etc. 142 on the database 140, the location 132 can provide updates and save such updates on the database 140 so that the database 140 has the latest policies, rules, regulations, information, etc. 142 for that location. The server 102 will allow the database to be open for any location to add their address, policies/rules/information/etc. 142, location name, etc. In this way, when the server 102 sends a request, it just needs to use the location name or address to select/retrieve such stored policies/rules/information/etc. 142 in order to provide such information to the user.

In block 714, the database sends the policies/rules/information/etc. 142 to the server 102. This may be achieved by the server 102 querying the database 140 with the received location and then the database 140 returning the policies/rules/information/etc. 142 that matches such received location.

In block 716, the server then analyzes and determines the deviations between the user's known areas and the location being traveled to. To do this, the server 102 may compare the home area of the user with the area of the location/destination to determine how familiar the user is with such area. If the location in an area that the user does not regularly visit, such as in a country foreign to the user, in a state foreign to the user, etc., the server 102 will determine that the user should receive policies of the location that are different from the user is used to. In this regard, the server 102 will compare the policies, rules, regulations, etc. of the location/destination with similar locations comparable to where the user has gone to before and any deviations therebetween will be noted as information that should be provided to the user.

For all deviations, the system will determine that these rules, regulation, information, etc. 142 are relevant for the user and/or would be useful for the user. Moreover, there are other ways to determine information relevant for the user, as provided in block 718. For example, if the user is traveling to a grocery store that just changed their policy about not providing bags to carry out groceries, the server 102 may determine that the user is traveling to a location where the user is likely unaware of such changes (particularly if the server 102 recognizes that the user has not been to the store since the policy change). This is based on the server 102 knowing when the policy change occurred (based on publicly available information that the server 102 found on the internet or based on the stored updating database 140 with such information) as well as pulling data from a database (either database 140 or another database) indicating the last time the user has visited the grocery store.

In block 720, the server 102 requests the user rules 118 and reminder settings 120 from the user's device 114 and/or from a database or from the server 102 (based on where such user rules 118 and reminder settings 120 are stored). The user rules 118 and reminder settings 120 are then transmitted to the server 102 (such as from the user's device 114 to the server 102, as shown in block 722).

In block 723, the server 102 determines which notifications, information, rules, regulation, etc. 142 that should be sent to the user's device. This may include analyzing the user's data including who the user is traveling with, the location the user is going, how familiar the user is with the location, needs of the user, needs of the user's party traveling to the location, information that may not be obvious (e.g., weather conditions based on querying a weather database), how recent the policy has changed, whether the user has been to the location since policy changes, if the information has already been sent to the user within a predetermined amount of time, etc. When analyzing this data, the system will determine what information, rules, regulation, etc. 142 are relevant for the user and/or would be useful for the user. For example, if the user is traveling to a grocery store that just changed their policy about not providing bags to carry out groceries, the server 102 may determine that the user is traveling to a location where the user is likely unaware of such changes (particularly if the server 102 recognizes that the user has not been to the store since the policy change). This is based on the server 102 knowing when the policy change occurred (based on publicly available information that the server 102 found on the internet or based on the stored updating database 140 with such information) as well as pulling data from a database (either database 140 or another database) indicating the last time the user has visited the grocery store.

The server 102 may also determine the correct timing to send the notifications and information. For example, the server 102 should warn the user about what he needs to know for various situations at particular times/events/triggers occurring, such as when the user: (1) searches for directions to the location type the address into his GPS system, (2) is doing his shopping list, (3) is looking at his e Wallet application to check his electronic tickets or clipped eCoupons (4) enters the geofenced area (similar to areas 202, 206, and 210 of FIGS. 2-5) beside the location, (5) while the user is still in his vehicle, and the like. The notifications could be sent immediately when these items occur and are sent in accordance with the user's rules 118 and reminder settings 120.

In block 724, the server 102 selects alerts, notifications, etc. of the information, policies, rules, regulations, etc. 142 associated with the location to send to the user's device 114. In some embodiments, the information, policies, rules, regulations, etc. are only sent in accordance with the user's rules 118 and reminder settings 120 set up by the user. In this regard, the server 102 will determine whether or not to send the information, policies, rules, regulations, etc. based on the user's prestored settings.

In some embodiments, the server 102 will send such information, policies, rules, regulations, etc. 142 when the user arrives at the location 132 or can provide an immediate alert in response to receiving the address of the received location 132 (after retrieving the information, policies, rules, regulations, etc. 142 of that location).

Once the user receives the information, policies, rules, regulations, etc. of the location, the user will be able to act accordingly.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the present disclosure is not intended to be exhaustive or to limit the present disclosure to the precise form disclosed above. While specific embodiments of, and examples for, the present disclosure are described above for illustrative purposes, various equivalent modifications are possible within the scope of the present disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the present disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the present disclosure can be modified, if necessary, to employ the systems, functions, and concepts of the various references described above to provide yet further embodiments of the present disclosure.

These and other changes can be made to the present disclosure in light of the above Detailed Description. While the above description describes certain embodiments of the present disclosure, and describes the best mode contemplated, no matter how detailed the above appears in text, the present disclosure can be practiced in many ways. Details of the system may vary considerably in its implementation details, while still being encompassed by the present disclosure disclosed herein. As noted above, particular terminology used when describing certain features or aspects of the present disclosure should not be taken to imply that the terminology is being redefined herein to be restricted to any specific characteristics, features, or aspects of the present disclosure with which that terminology is associated. In general, the terms used in the following claims should not be construed to limit the present disclosure to the specific embodiments disclosed in the specification, unless the above Detailed Description section explicitly defines such terms. Accordingly, the actual scope of the present disclosure encompasses not only the disclosed embodiments, but also all equivalent ways of practicing or implementing the present disclosure under the claims.

While certain aspects of the present disclosure are presented below in certain claim forms, the inventors contemplate the various aspects of the present disclosure in any number of claim forms. For example, while only one aspect of the present disclosure may be recited as a means-plus-function claim under 35 U.S.C sec. 112(f), other aspects may likewise be embodied as a means-plus-function claim, or in other forms, such as being embodied in a computer-readable medium. (Any claims intended to be treated under 35 U.S.C. § 112(f) will begin with the words “means for”.) Accordingly, the inventors reserve the right to add additional claims after filing the application to pursue such additional claim forms for other aspects of the present disclosure.

What is claimed is:

1. A method comprising:
receiving, at a server from a user's device comprising a processor over a network, travel data comprising a location being traveled to by a user;
retrieving, from a database over the network, data comprising policies and information associated with the received location;
selecting, by the server, which policies and information associated with the received location should be sent to the user's device; and
sending, from the server to the user's device over the network, the selected policies and information associated with the received location.

2. The method of claim 1, further comprising:
determining when the user has entered a geographic area proximate to the location; and
in response to the user entering the geographic area proximate to the location, sending the selected policies to the user's device.

3. The method of claim 1, further comprising:
determining what policies and information are associated with various locations by accessing publicly-available databases or websites;
saving, to the database, the policies and information that are associated with various locations in order to build a database of policies and information.

4. The method of claim 1, wherein a device at the received location creates, stores and updates, at the database, the policies and information associated with the received location so that the server can retrieve and use in the future the policies and information associated with the received location.

5. The method of claim 1, further comprising:
requesting user settings from the user device relating to reminders under certain triggering conditions; and
determining what alerts to send to the user in accordance with the user settings;
determining that one of the triggering conditions has been met; and
preventing sending the alerts to the user's device in response to the server determining that the user settings indicate to not provide reminders and that one of the triggering conditions has been met.

6. The method of claim 1, further comprising:
determining deviations between the user's home area and the area where the received location is located; and
in response to determining that the deviations has exceeded a threshold, determining that the deviations should be provided to the user.

7. The method of claim 1, further comprising:
determining others that are traveling with the user; and
determining information about the location to provide to the user based on information relating to others traveling with the user.

8. The method of claim 1, wherein the policies and information associated with the received location comprises one or more of the following:
bringing your own bags,
whether pumping gas is self-pump only or attendant-pump only,
the location does not accept cash,
whether the location is self-checkout only,
the location the user is going to does not take certain credit cards,
what the parking policies are,
what items are allowed and not allowed in the location,
if the location is kid-friendly,
information about weapons,
a tipping policy at the location,
what the bag policy is, and
how to access shopping carts.

9. The method of claim 1, wherein the server is configured to alert the user about in response to certain triggers comprising one of the following: (1) when the user searches for directions to a location and types the address into the user's device, (2) when the user is doing a shopping list, (3) when the user is looking at an eWallet application to check the user's electronic tickets or clipped eCoupons (4) when the user enters the geofenced area beside the location.

10. A system comprising:
a server comprising a processor configured for:
receiving, at a server from a user's device comprising a processor over a network, travel data comprising a location being traveled to by a user;
retrieving, from a database over the network, data comprising policies and information associated with the received location;
selecting, by the server, which policies and information associated with the received location should be sent to the user's device; and
sending, from the server to the user's device over the network, the selected policies and information associated with the received location.

11. The system of claim 10, wherein the server is further configured to:
determine when the policies and information associated with the received location should be sent to user;
sending the policies and information associated with the received location when the user arrives at an area proximate to the received location in response to determining that the policies and information associated with the received location should be sent when the user is at the location; and
sending the policies and information associated with the received location immediately in response to determining that the policies and information associated with the received location should be sent as soon as the server receives the policies and information.

12. The system of claim 10, wherein the server is further configured to:
determine what policies and information are associated with various locations by accessing publicly-available databases or websites;
store, to the database, the policies and information that are associated with various locations in order to build a database of policies and information.

13. The system of claim 10, wherein the server is configured to alert the user about in response to certain triggers comprising one of the following: (1) when the user searches for directions to a location and types the address into the user's device, (2) when the user is doing a shopping list, (3) when the user is looking at an eWallet application to check the user's electronic tickets or clipped eCoupons (4) when the user enters the geofenced area beside the location.

14. The system of claim 10, wherein the server is configured for:
determining others that are traveling with the user; and
determining information about the received location to provide to the user based on information relating to others traveling with the user.

15. A user device comprising:
a processor configured for:
sending, to a server over a network, a location of a user;
determining that the user has entered a predetermined zone associated with a predefined location, wherein upon entering in such predetermined zone, the server retrieves, from a database over the network, data comprising policies and information associated with the location;
receiving, from the server over the network, the policies and information associated with the received location.

16. The user device of claim 15, wherein the processor is further configured for:
sending information associated with the user so the server can determine which portions of the policies and information to select; and
receiving the selected portions of the policies and information.

17. The user device of claim 15, wherein the processor is further configured for:
sending, to the server. information on others that are traveling with the user; and
receiving, from the server, information about the received location based on information relating to the others traveling with the user.

18. The user device of claim 15, wherein the processor is further configured for:
sending user settings relating to reminders under certain triggering conditions such that the user's device requests to not receiving reminders from the server when one of the triggering conditions has been met, wherein
the server prevents sending reminders to the user's device in response to the server determining that the user settings indicate to not provide reminders and that one of the triggering conditions has been met.

19. The user device of claim 15, wherein the processor is further configured for:
an antenna configured to periodically send location information of the user's device to the server, wherein the server compares the locations of the user with predetermined zones associated with locations to determine if the user's device has entered one of the predetermined zones.

20. The user device of claim 15, wherein the processor is further configured for:
sending an address which the user intends to travel to; and
receiving the policies and information prior to the user arriving at the location.
